(19) United States
(12) Patent Application Publication
(10) Pub. No.: US 2023/0303859 A1
(43) Pub. Date: Sep. 28, 2023

(54) WATERBORNE WOOD COATING COMPOSITION AND WOOD ARTICLE MANUFACTURED THEREFROM

(71) Applicant: Guangdong Huarun Paints Co., Ltd., Guangdong (CN)

(72) Inventors: Hongbin CHEN, Guangdong (CN); Jun ZHANG, Guangdong (CN)

(21) Appl. No.: 18/021,630

(22) PCT Filed: Sep. 13, 2021
(86) PCT No.: PCT/CN2021/117984

§ 371 Date: Feb. 16, 2023

(30) Foreign Application Priority Data
Sep. 15, 2020 (CN) 202010970074.3

(51) Int. Cl. C09D 5/02; C09D 15/00; C09D 175/04

(52) U.S. Cl. CPC C09D 5/028; C09D 15/00; C09D 175/04

(57) ABSTRACT

The present application relates to a waterborne wood coating composition and wood article manufactured therefrom. The waterborne wood coating composition comprise i) a waterborne paint comprising an aqueous dispersion of polymer particles, and optional additional additives, comprising pigments/fillers, cosolvents, thickeners, leveling agents, defoamers or any combination thereof; and ii) oligosiloxane, the oligosiloxane having one or more functional groups that are hydrolysable to release small molecules, wherein the waterborne wood coating composition forms a coating film having a 60° gloss of not higher than 40.

### TECHNICAL FIELD

The present application relates to a waterborne wood coating composition. More specifically, the present application relates to a waterborne wood coating composition capable of forming a low gloss, even matte coating film, and wood articles manufactured therefrom.

### BACKGROUND

At present, environment and energy are two major challenges that people face. In order to meet this challenge, the coating industry is gradually shifting from traditional varieties of high pollution, high energy consumption, and extremely dependent on petroleum industry products to environmentally friendly and resource-saving products such as waterborne coatings, radiation curable coatings, powder coatings and high-solid coatings. With the introduction of the Chinese chemical industry standard of “Indoor Waterborne Wood Coatings”, waterborne wood coatings have developed rapidly. At present, the investment in research and development of waterborne wood paint is increasing substantially, and the requirements for waterborne wood paint are also increasing.

In the wood application market, low-gloss or matte coatings are favored by consumers because of their soft luster and delicate touch. Currently, in the production of low-gloss waterborne wood coatings, a well-known matting solution is to apply inorganic matting agents such as silica or organic matting agents such as synthetic wax or metal stearate in the waterborne wood coatings. These matting agents are mainly physical matting agents. For example, silica-based inorganic matting agents can cause the coating to form a micro-rough film surface after the coating is dried, resulting in a gloss reduction effect or even a matte effect; synthetic wax-based organic matting agent can float on the outermost surface to modify the coating after the paint is dried, thereby affecting gloss of the coating. However, these known matting agents have more or less disadvantages. In terms of cost, the application of silica-based inorganic matting agent in the formulation of waterborne wood matt paint is the most convenient. However, this kind of matting method has disadvantages such as powder sedimentation, poor touch of the coating, and poor transparency. Organic matting agents such as synthetic waxes and metal stearates are not widely used in the preparation of waterborne wood matt paints, and they have the disadvantages of excessive cost or insufficient performance.

Therefore, in the wood coating industry, there is an urgent need for improved waterborne coatings that are capable of forming low gloss and even matte coatings.

### SUMMARY

In one aspect, the present application discloses a waterborne wood coating composition comprising: i) a waterborne paint comprising an aqueous dispersion of polymer particles, and optionally, at least one additional additive, comprising at least one pigment/filler, at least one cosolvent, at least one thickener, at least one leveling agent, at least one defoamer, or any combination thereof; and ii) at least one oligosiloxane, the at least one oligosiloxane having one or more functional groups that are hydrolysable to release small molecules, wherein the waterborne wood coating composition forms a coating film having a 60° gloss of not higher than 40 (as tested using the gloss meter described herein).

In some embodiments of the present application, the waterborne paint contained in the waterborne wood coating composition comprises an aqueous dispersion of polymer particles having one or more active hydrogen functional groups.

In some embodiments of the present application, the at least one oligosiloxane contained in the waterborne wood coating composition further comprises one or more moieties with an active hydrogen reactive functional group, in addition to one or more functional groups that are hydrolysable to release small molecules. In such an embodiment, the oligosiloxane may have a structure represented by Formula 1:

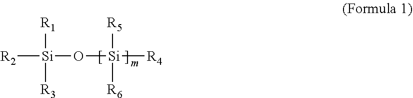

in which

at least one of R₁, R₂, R₃, R₄, R₅, and R₆ is a functional group that is hydrolysable to release small molecules, and the functional group is one or more selected from C₁-C₆ alkoxy, C₂-C₆ alkenyloxy, C₆-C₁₀ aryloxy group, C₁-C₆ alkanoyloxy group, C₆-C₁₀ aroyloxy group, C₁-C₆ alkane oxime group and C₆-C₁₀ aryl ketoxime group, preferably from C₁-C₆ alkoxy; and

at least one of R₁, R₂, R₃, R₄, R₅, and R₆ is a moiety with an active hydrogen-reactive functional group, and the active hydrogen-reactive functional group is one or more selected from epoxy groups, hydroxyl groups, amino groups, and isocyanate groups, preferably from epoxy groups; and

m is not 0, preferably an integer from 1 to 10.

In some another embodiments of the present application, the at least one oligosiloxane contained in the waterborne wood coating composition further comprises two or more moieties with an active hydrogen reactive functional group, in addition to one or more functional groups that are hydrolysable to release small molecules. In such an embodiment, the oligosiloxane has a structure represented by Formula 2:

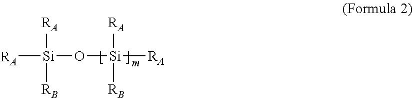

R_{A} represents a functional group that is hydrolysable to release small molecules, and the functional group is one or more selected from C₁-C₆ alkoxy, C₂-C₆ alkenyloxy, C₆-C₁₀ aryloxy group, C₁-C₆ alkanoyloxy group, C₆-C₁₀ aroyloxy group, C₁-C₆ alkane oxime group and C₆-C₁₀ aryl ketoxime group, preferably from C₁-C₆ alkoxy; and

R_{B} represents a moiety with an active hydrogen-reactive functional group, and the active hydrogen-reactive functional group is one or more selected from epoxy groups, hydroxyl groups, amino groups, and isocyanate groups, preferably from epoxy groups; and

m is not 0, preferably an integer from 1 to 10.

In some embodiments of the present application, the at least one oligosiloxane contained in the waterborne wood coating composition is substantially insoluble in water.

In another aspect, the present application discloses a wood article, comprising a wood substrate having at least one major surface; and at least one coating film, the coating film being formed by the waterborne wood coating composition according to the present application directly or indirectly applied on the at least one major surface.

It has been surprisingly found that in the formulation of a waterborne wood coating composition, at least one oligosiloxane having one or more functional groups that are hydrolysable to release small molecules is added to the waterborne paint, so that the waterborne wood coating composition thus obtained can achieve a matting effect produced by chemical means, thereby forming a low gloss, even matt coating film.

It has been further surprisingly found that in the formulation of the waterborne wood coating composition, the at least one oligosiloxane further comprising one or more moieties with an active hydrogen reactive functional group, in addition to one or more functional groups that are hydrolysable to release small molecules, is introduced and combined with a waterborne paint comprising an aqueous dispersion of polymer particles having active hydrogen functional groups, so that this kind of oligosiloxane can not only chemically make the coating film matt, promote the formation of a reduced gloss or even matt coating film, but also participate in the film formation process of the coating film, thereby improving performances of the coating film, such as chemical resistance of the coating film, especially alkali resistance of the coating film.

The details of one or more embodiments disclosed herein are set forth in the description below. Other features, objects, and advantages disclosed herein will be apparent from the description, and from the claims.

### DESCRIPTION OF DRAWINGS

FIG. 1 shows the coating surface of the coating films analyzed by electron microscopy, which are formed by the waterborne wood coating composition of Example 2 according to the present application or the waterborne paint of the control sample 1 in which the left picture is the coating film of the control sample 1 and the right picture shows the coating film of Example 2 according to the present application.

FIG. 2 shows the infrared spectrum of coatings measured by Fourier Transform Attenuated Total Reflection Infrared Spectroscopy, which coatings are formed by the waterborne wood coating composition of Example 2 of the present application, the oligosiloxane incorporated into the waterborne wood coating composition of Example 2 or the waterborne paint of the control sample 1, in which the top curve is the coating of the control sample 1, the middle curve is the coating film of oligosiloxane, and the bottom curve is the coating based on Example 2 of the present application.

### DEFINITION

As used herein, “a”, “an”, “the”, “at least one”, and “one or more” are used interchangeably. Thus, for example, a coating composition that comprises “an” additive can be interpreted to mean that the coating composition includes “one or more” additives.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned herein, as along as such components or steps do not affect the basic and novel characteristics of what is disclosed herein, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, “coating,” “coating film,” and “paint film” have the same meaning, and both are formed by applying and drying the waterborne wood coating composition.

When used for the “waterborne wood coating composition”, the phrase “the coating film formed by the waterborne wood coating composition has a 60-degree gloss of not higher than 40” means that the coating film formed from the waterborne wood coating composition shows a lower gloss effect, so the above-mentioned waterborne wood coating composition can also be referred to as a low-gloss waterborne wood coating composition.

In the context of the present application, the term “oligosiloxane” refers to a type of oligomer with a main chain composed of repeated Si—O bonds and organic groups directly connected to the silicon atoms, wherein the organic groups may include alkyl, aryl, alkoxy, aryloxy or other organic groups known to those skilled in the art.

When used for “oligosiloxane”, the term “one or more functional groups that are hydrolysable to release small molecules” refers to such a functional group that is directly connected to the silicon atom on the main chain of the oligosiloxane, and can be hydrolyzed in the presence of an aqueous medium to form small molecules that can be removed from the system, such as volatile small molecules. As an exemplary illustration, the small molecules that can be removed by hydrolysis include, but are not limited to, at least one alcohol, at least one carboxylic acid, at least one oxime, water, or combinations thereof.

When used for “oligosiloxane”, the phrase “not substantially soluble in water” or “substantially insoluble in water” means that the oligosiloxane will not be uniformly dispersed in an aqueous medium (for example, water) on a molecular scale to form a homogeneous solution. In some embodiments of the present application, the oligosiloxane may be dispersed in water in the form of nano-scale particles, so that the resulting dispersion is light-permeable and clear and transparent, or may be dispersed in water in the form of micro-scale particles, so that the resulting dispersion is opaque or semi-transparent and foggy.

In the context of the present application, the term “matting powder” includes silica matting agents, synthetic wax matting agents and stearate-based matting agents. When used for “waterborne wood coating composition”, the phrase “substantially free of a matting powder” means that components of the waterborne wood coating composition and the coating composition as formulated do not contain any additional above-mentioned matting powder, preferably does not contain any matting powder known in the art. When the phrase “substantially free of” is used herein, such phrase is not intended to exclude the presence of trace amounts of related matting powders that may exist as environmental pollutants or due to environmental pollution.

The term “oligomer” or “oligo” as used herein refers to such polymer having a relatively low number of repetitions of units derived, actually or conceptually, from molecules of low relative molecular mass. Generally in an oligomer adding or removing even one repeat unit from the oligomer has a significant effect on the properties of the resultant oligomer.

The term “small molecules” as used herein refers to molecules having a relatively low molecular weight. “Small molecules” may also be described as those molecules having a molecular weight of 1 kiloDalton (kDa) or less. “Small molecules” may also be described as those molecules having a molecular weight in the range of 0.1 to 1.0 kDa. In particular, small molecules may include, but are not limited to, at least one alcohol, at least one carboxylic acid, at least one oxime, water, and combinations thereof.

The term “comprises”, “comprising”, “contains” and variations thereof do not have a limiting meaning where these terms appear in the description and claims.

The terms “preferred” and “preferably” refer to embodiments disclosed herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of what is disclosed herein.

### DETAILED DESCRIPTION

The present application in one aspect provides a waterborne wood coating composition comprising: i) a waterborne paint comprising an aqueous dispersion of polymer particles, and optionally, at least one additional additive comprising at least one pigment/filler, at least one cosolvent, at least one thickener, at least one leveling agent, at least one defoamer, or any combination thereof; and ii) at least one oligosiloxane, the at least one oligosiloxane having one or more functional groups that are hydrolysable to release small molecules, wherein the waterborne wood coating composition forms a coating film having a 60-degree gloss of not higher than 40.

As mentioned above, the waterborne wood coating composition according to the present application can form a coating film having a 60-degree gloss of not higher than 40, so the waterborne wood coating composition according to the present application can also be called a low-gloss waterborne wood coating composition. Preferably, the coating film formed by the waterborne wood coating composition of the present application preferably has a 60-degree gloss of not higher than 35, more preferably a 60-degree gloss of not higher than 30, even more preferably a 60-degree gloss of not higher than 25, still even more preferably a 60-degree gloss of not higher than 20. Therefore, the preferred waterborne wood coating composition according to the present application can also be referred to as a matte waterborne wood coating composition.

In an embodiment according to the present application, the waterborne wood coating composition comprises at least one oligosiloxane, which is present in the waterborne wood coating composition in a distinguishable form as a separate component. In the context of the present application, “oligosiloxane” refers to a type of oligomer with a main chain composed of repeated Si—O bonds and organic groups directly connected to the silicon atoms, wherein the organic groups may include alkyl, aryl, alkoxy, aryloxy or other organic groups known to those skilled in the art.

In an embodiment according to the present application, the at least one oligosiloxane may have one or more functional groups that are hydrolysable to remove small molecules. As mentioned above, these functional groups are directly connected to silicon atoms of the main chain of the at least one oligosiloxane, and can be hydrolyzed in the presence of an aqueous medium, so that small molecules, such as volatile small molecules, can be removed. The generation of these small molecules causes pits on the surface of coating film formed by the waterborne wood coating composition containing the at least one oligosiloxane, resulting in a rough surface. As suitable examples of functional groups that are hydrolysable to remove small molecules, hydroxyl, alkoxy, alkenyloxy, aryloxy, alkanoyloxy, aroyloxy, alkane oxime, and aryl ketoxime can be given. As an exemplary illustration, the small molecules that can be removed by hydrolysis include, but are not limited to, at least one alcohol, at least one carboxylic acid, at least one oxime, water, or combinations thereof.

In order to more clearly illustrate the processes that at least one oligosiloxane is hydrolyzed to remove small molecules during the coating film formation, several schematic descriptions are provided as follows:
Process 1: ≡Si—OR+3H₂O→≡Si—OH+3ROH↑;
Process 2: ≡Si—OH+HO—Si≡→≡Si—O—Si≡+H₂O;
Process 3: ≡Si—OR+HO—Si≡→≡Si—O—Si≡+ROH;
Process 4: Polymer particle-OH+HO—Si/RO—Si≡→≡Si—O—Si≡+H₂O/ROH.

As shown in the above removal process of small molecules by hydrolysis, in the film formation process of the waterborne wood coating composition, at least one oligosiloxane containing one or more functional groups that are hydrolysable to remove small molecules can be hydrolyzed to produce volatile small molecules (such as alcohols), and/or can self-condensate to form water molecules or volatile small molecules, and/or can react with hydroxyl groups present in polymer particles to form water molecules or volatile small molecules. In some embodiments of the present application, the hydroxyl groups present in polymer particles are introduced by reacting polymer particles having carboxylic acid functional groups with at least one oligosiloxane having epoxy functional groups to undergo a ring-opening reaction, so that the hydroxyl group is introduced into the particles. During the formation of the coating film, one or more of the above processes can be performed simultaneously or sequentially. it has been surprisingly found that incorporation of at least one oligosiloxane having one or more functional groups that are hydrolysable to release small molecules into a waterborne paint may obtain a waterborne wood coating composition exhibiting a low gloss effect, or may obtain a waterborne wood coating composition even exhibiting a matt effect. Without being bound by any theory, it is believed that compared with small molecule silanes, hydrolysis of oligosiloxanes with one or more hydrolyzable functional groups is a slower process, during which the volatile molecules as formed are continuously released in the form of bubbles, rise to the surface of the coating film, and then break to form pits, resulting in rough surface of the coating film; moreover, the oligosiloxane will self-condensate into organosilicon microparticles and the formed organosilicon microparticles have a lower surface tension than surrounding resin, which causes pits in the coating film, resulting in a rough surface of the coating film. Under the synergistic effect of the above two, the at least one oligosiloxane can effectively reduce gloss of the coating film, so that a gloss-reduced or matte waterborne wood coating composition can be successfully formulated therefrom.

In one embodiment of the present application, the at least one oligosiloxane further includes one or more moieties with active hydrogen reactive functional groups. The incorporation of this kind of oligosiloxane can not only provide a matting effect for the coating film, but also can undergo a cross-linking reaction to participate in the formation of the coating film, thereby improving mechanical properties of the coating film.

In such an embodiment, as an exemplary illustration, the at least one oligosiloxane may have a structure represented by Formula 1:

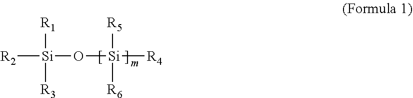

in which

at least one of R₁, R₂, R₃, R₄, R₅, and R₆ is a functional group that is hydrolysable to release small molecules, and the functional group is one or more selected from C₁-C₆ alkoxy, C₂-C₆ alkenyloxy, C₆-C₁₀ aryloxy group, C₁—C₆ alkanoyloxy group, C₆—C₁₀ aroyloxy group, C₁—C₆ alkane oxime group and C₆-C₁₀ aryl ketoxime group, preferably from C₁-C₆ alkoxy; and

at least one of R₁, R₂, R₃, R₄, R₅, and R₆ is a moiety with an active hydrogen-reactive functional group, and the active hydrogen-reactive functional group is one or more selected from epoxy groups, hydroxyl groups, amino groups, and isocyanate groups, preferably from epoxy groups; and

m is not 0, preferably an integer from 1 to 10.

In another embodiment of the present application, the at least one oligosiloxane further comprises two or more moieties with at least one active hydrogen reactive functional group. The incorporation of this kind of oligosiloxane can not only provide a matting effect for the coating film, but also can have a plurality of functional groups that may crosslink with polymer particles, so that the resulting coating film may have improved chemical resistance, especially improved alkali resistance.

In such an embodiment, as an exemplary illustration, the at least one oligosiloxane has a structure represented by Formula 2:

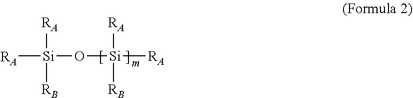

R_{A} represents a functional group that is hydrolysable to release small molecules, and the functional group is one or more selected from C₁-C₆ alkoxy, C₂-C₆ alkenyloxy, C₆-C₁₀ aryloxy group, C₁₀-C₆ alkanoyloxy group, C₆-C₁₀ aroyloxy group, C₁-C₆ alkane oxime group and C₆-C₁₀ aryl ketoxime group, preferably from C₁-C₆ alkoxy; and

R_{B} represents a moiety with an active hydrogen-reactive functional group, and the active hydrogen-reactive functional group is one or more selected from epoxy groups, hydroxyl groups, amino groups, and isocyanate groups, preferably from epoxy groups; and

m is not 0, preferably an integer from 1 to 10.

In some embodiments according to the present application, the at least one oligosiloxane is substantially insoluble in water. In one embodiment, the at least one oligosiloxane is insoluble in water. In another embodiment, the at least one oligosiloxane is hardly soluble in water. It has been surprisingly discovered that the solubility characteristics of oligosiloxane in an aqueous medium are particularly advantageous for the formation of surface roughness of the coating film. Therefore, in a preferred embodiment of the present application, the oligosiloxane may be dispersed in an aqueous medium in the form of nanoparticles or microparticles, preferably in a waterborne paint.

The above-mentioned at least one oligosiloxane is self-made or commercially available from various suppliers.

According to an embodiment of the present application, the amount of at least one oligosiloxane can be varied within an appropriate range as required. In some embodiments according to the present application, relative to the total weight of the waterborne paint, the at least one oligosiloxane may be present in an amount of 1 to 10 wt %, preferably in an amount of 3 to 10 wt %, more preferably in an amount of 4 to 10 wt %, and even more preferably in an amount of 4 to 8 wt %. The at least one oligosiloxane within the above-mentioned amount range is conducive to reducing gloss of the coating film formed from the waterborne wood coating composition and improving chemical resistance of the coating film formed from the waterborne wood coating composition.

In an embodiment according to the present application, the waterborne wood coating composition further includes a waterborne paint in addition to the at least one oligosiloxane. The waterborne paint, as the main body of the waterborne wood coating composition, comprises conventional coatings components used to formulate the waterborne wood coating composition, including, but not limited to, an aqueous dispersion of polymer particles, water, additional additives, and so on.

In an embodiment, the waterborne paint comprises an aqueous dispersion of polymer particles. As used herein, the term “aqueous dispersion of polymer particles” refers to a stable dispersion of synthetic resin (i.e. polymer) in the form of microparticles in an aqueous liquid medium, optionally with the aid of suitable dispersing aids such as surfactant. Thus, when used for polymers in the present application, the terms “aqueous latex” and “aqueous dispersion” can be used interchangeably unless otherwise stated. The method for preparing the aqueous latex is known in the art. For example, it can be prepared by an emulsion polymerization process known to those skilled in the art. The emulsion polymerization preparation process usually includes the following steps: optionally under the action of a suitable emulsifier(s) and/or dispersion stabilizer(s) and with the aid of stirring, polymerizable monomer(s) is dispersed into an emulsion in water, and for example, initiated to polymerize by adding an initiator.

It is well known that polymer particles in an aqueous latex can be modified to obtain an aqueous latex with desired properties. In one embodiment of the present application, the polymer particles are modified by active hydrogen functional groups. In one aspect, active hydrogen can be provided by functional groups such as —COOH, —OH, —SH, secondary amino groups, primary amino groups, or combinations thereof. In addition, some functional groups, such as ester groups (especially carboxylate groups), thioether groups, or acid anhydride groups (especially carboxylic acid anhydride groups) can be converted into functional groups capable of providing active hydrogen, for example, by hydrolysis. Therefore, in the present application, polymer particles with one or more active hydrogen functional groups refer to any polymer particles that themselves contain functional groups capable of providing active hydrogen and/or contain any polymer particles comprising functional groups that can be converted into those capable of providing active hydrogen during the preparation and/or application of the system.

In an embodiment according to the present application, an aqueous dispersion of polymer particles having one or more active hydrogen functional groups is regarded as a film-forming resin component in a waterborne paint. On the one hand, this resin component acts as a binder to provide adhesion between the coating film and substrate, and to keep the components (such as fillers) in the waterborne paint together and give the coating film a certain cohesion strength. On the other hand, the polymer particles have good reactivity with the at least one oligosiloxane having active hydrogen reactive functional groups, so as to achieve crosslinking of polymer chains, thereby forming a coating film coating with a three-dimensional network structure.

In some embodiments of the present application, polymer particles in the aqueous latex may have one or more active hydrogen functional groups selected from —COOH, —OH, —SH, secondary amino groups, primary amino groups, or combinations thereof. In one embodiment, the one or more active hydrogen functional groups is carboxyl functionalized.

In some embodiments of the present application, the aqueous dispersion of polymer particles comprises an aqueous dispersion of vinyl acetate resin, an aqueous dispersion of acrylics resin, an aqueous dispersion of silicone resin, an aqueous dispersion of polyurethane resin, an aqueous dispersion of polyurethane acrylics resin, an aqueous dispersion of fluoropolymer resin, or any combination thereof In many embodiments, the aqueous dispersion of polymer particles comprises an aqueous dispersion of vinyl acetate polymer particles, an aqueous dispersion of acrylics polymer particles, an aqueous dispersion of silicone polymer particles, an aqueous dispersion of polyurethane polymer particles, an aqueous dispersion of polyurethane polyacrylic polymer particles, an aqueous dispersion of fluoropolymer polymer particles, or any combination thereof.

In an embodiment according to the present application, polymer particles in the aqueous dispersion have a certain range of particle diameters, and can be measured by a Z average particle diameter known in the art, which Z average particle diameter means a particle size as measured with a dynamic light scattering method by for example, Marvlen Zetasizer 3000HS microscopic particle size analyzer. Preferably, polymer particles of the aqueous dispersion may have a particle size in the range of 50 nm to 200 nm. It has been surprisingly discovered that an aqueous dispersion of polymer particles having the above-mentioned particle size range is particularly suitable for formulating a waterborne wood coating composition, and the resulting wood coating composition formulated therefrom has suitable rheology and coatability.

In an embodiment of the present application, the aqueous dispersion of polymer particles has a solid content of 30-50%. From the perspective of industrial practice, an aqueous dispersion of polymer particles with the above solid content is available easily. The above-mentioned aqueous dispersions of polymer particles can be self-made or are commercially available products.

According to an embodiment of the present application, the amount of the aqueous dispersion of polymer particles can be varied within a wide range, and the total amount thereof relative to the total weight of the waterborne paint can be in the range of about 60 wt % to about 85 wt %. In some embodiments, the amount of the aqueous dispersion of polymer particles may be in the range of 75 wt % to 85 wt %.

According to some embodiments of the present application, the waterborne paint may further include a certain amount of aqueous carrier, such as water, so as to obtain an appropriate coating viscosity.

According to some embodiments of the present application, the waterborne paint may contain pigments/fillers as needed to impart desired color and/or strength to the resulting coating film or coating. The term “pigments/fillers” as used herein refers to any volume extender suitable for coatings, which may be in the form of organic or inorganic, such as particulate. There is no particular limitation on the shape of particles, and they can have any appropriate shape. The average particle size of particles can vary within a wide range, for example within a range of about 10 nanometers to about 50 microns. Some particulate materials, in addition to functioning as volume extenders for coatings, also impart one or more desired properties to the composition and/or the coating formed from the composition. For example, some particulate materials can impart a desired color to the composition and the coating resulting from the composition. In this case, this particulate material is also called “pigments”. Some particulate materials can improve chemical and/or physical properties, especially mechanical properties of the coating obtained from the composition. In this case, this particulate material is also referred to as “fillers”.

In an embodiment of the present application, suitable exemplary pigments/fillers include, for example, kaolin, titanium oxide, calcium carbonate, diatomaceous earth, talc, barium sulfate, magnesium aluminum silicate, silica, or any combination thereof. In one embodiment, the filler may include titanium oxide, kaolin, calcium carbonate, diatomaceous earth, or a combination thereof.

According to some embodiments of the present application, the total amount of pigments/fillers can vary within a wide range, for example, the total amount thereof is about 0% by weight to about 60% by weight, preferably about 0.1% by weight to about 60% by weight, and more preferably about 10% by weight to about 50% by weight relative to the total weight of the waterborne paint.

According to an embodiment of the present application, the waterborne paint may optionally further include other additional additives commonly used in waterborne wood coating compositions, and these additives will not adversely affect the coating composition or the cured coating obtained therefrom. Suitable additives include, but are not limited to, those that improve processing or manufacturing properties of the composition, enhance aesthetics of the composition, or improve specific functional properties or characteristics (such as adhesion to the substrate) of the coating composition or the cured composition obtained therefrom. The additional additives that can be included are, for example, cosolvents, defoamers, leveling agents, thickeners, lubricants, anti-migration aids, anti-fungal agents, preservatives, wetting agents, bactericides, anti-rust agents, antioxidants, dispersants, adhesion promoters, UV stabilizers, pH adjusters, film forming aids, or combinations thereof. The content of each optional component is sufficient to achieve its intended purpose, but preferably, such content does not adversely affect the waterborne wood coating composition or the coating film obtained therefrom. In some embodiments of the present application, the waterborne paint may further include one or more of cosolvents, defoamers, leveling agents, thickeners, surfactants, and bactericides. In one embodiment of the present application, the waterborne paint may further include one or more of cosolvents (including but not limited to dipropylene glycol monomethyl ether (DPM), and dipropylene glycol monobutyl ether (DPnB)), defoaming agents, leveling agents, and thickeners.

In a specific embodiment according to the present application, the waterborne paint comprises, relative to the total weight of the waterborne paint,
60-85 wt % of an aqueous dispersion of polymer particles;
10-30 wt % of water;
0-20 wt % of at least one additional additive, one or more of which are selected from solvents, defoamers, leveling agents and thickeners.
   Other additives are also contemplated.

In some embodiments according to the present application, the waterborne wood coating composition is substantially free of a matting powder, preferably completely free of a matting powder.

In some embodiments according to the present application, the waterborne wood coating composition formed by mixing the waterborne paint and at least one oligosiloxane is applied on an aged polyurethane panel with a wet film thickness of 150 microns and air-dried for 7 days, so the resultant coating film has a gloss reduction of 10% or higher, preferably 30% or higher, more preferably 50% or higher compared with the control coating film formed from the waterborne paint in the same manner.

In some embodiments according to the present application, the waterborne wood coating composition formed by mixing the waterborne paint and at least one oligosiloxane is applied on an aged polyurethane panel with a wet film thickness of 150 microns and air-dried for 7 days, so the resulting coating film has improved chemical resistance, and preferably has improved alkali resistance compared to conventional coating films with similar gloss.

In some embodiments according to the present application, the coating film formed by the waterborne wood coating composition of the present application is compared with the control coating film formed from the waterborne paint in combination with a commercially available matting agent and the coating film of the present application shows higher transparency in the event that both coating film have same gloss.

The preparation of the waterborne wood coating composition according to the present application can be achieved by any suitable mixing method known to those of ordinary skill in the art. For example, the waterborne wood coating composition can be made by adding an aqueous emulsion, water and additional additives to a container, and then mixing the resulting mixture until uniform, thereby forming a waterborne paint; and then mixing the resulting waterborne paint with an appropriate amount of oligosiloxane to obtain the final waterborne wood coating composition.

The waterborne wood coating composition of the present application can be applied by conventional methods known to those of ordinary skill in the art, for example, by brush, blade coating, spray coating, roll coating, or other conventional coating methods known to those of ordinary skill in the art.

### Wood Article

Another aspect of the present application provides a wood article, which comprises: a wood substrate having at least one major surface; and at least one coating film, the coating film being formed by the waterborne wood coating composition according to an embodiment of the present application directly or indirectly applied on the major surface.

In an embodiment of the wood article of the present application, the substrate is a wood substrate. As the wood substrate used to manufacture the wood article of the present application, any suitable wood substrate known in the art can be used. In the present application, the term “wood substrate” refers to any cellulose/lignin material derived from the hard, fibrous structural organization of the stems and roots of trees or other woody plants. Wood substrates include, for example, hardwood and softwood wood cut directly from trees, and engineered wood composites made of wood strips, wood chips, wood fibers, or wood veneers. Examples of wood composites include, but are not limited to, plywood, oriented strand board (OSB), medium density fiberboard (MDF), particle board, and the like. As an example of strand board, a melamine board, that is, a strand board treated with melamine, can be used.

Exemplary wood substrates may comprise hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosma j aponicum, Catalpa wood, Dryobalanops spp., fir, oak, rubber, wood composites, or combinations thereof.

As described above, the waterborne wood coating composition according to the present application is suitable for applying on the surface of a wood substrate as a top coat (“top coat” meaning a coating that is the last coating to be applied), thereby providing a low gloss or matte effect on the surface of the wood substrate.

The following examples describe the present application in more detail, which are for illustrative purposes only since various modifications and changes will be apparent to those skilled in the art from the scope of the present application. Unless otherwise indicated, all parts, percentages, and ratios reported in the following examples are on a weight basis and all reagents used in the examples are commercially available and may be used without further treatment.

### Test Methods

Electron microscopy test: The waterborne wood coating composition was applied on a polyvinyl chloride (PVC) black film with a wet film thickness of 150 microns and air dried for 7 days, and then surface morphology of the dry film was observed using LEICA DVM6.

Infrared test: The waterborne wood coating composition was applied on a polyvinyl chloride (PVC) black film with a wet film thickness of 150 microns and air-dried for 7 days, and then the sample coating was subjected to an attenuated total reflection test with US Thermo Nicolet Nexus 470-FTIR infrared spectrometer.

Gloss: The waterborne wood coating composition was applied on an aged polyurethane panel with a wet film thickness of 150 microns and air-dried for 7 days, and then the sample was tested using BYK4565 miniature BYK gloss meter for its 60° gloss.

Transparency: The waterborne wood coating composition was applied on a glass panel with a wet film thickness of 150 microns and air-dried for 7 days, and then the resulting coating film sample was measured with LS108 of Shenzhen Linshang Technology Co., Ltd. at 550 nm for visible light, 430 nm for blue light and 395 nm for ultraviolent light respectively for testing its transparency.

Chemical resistance: The waterborne wood coating composition was applied on an aged polyurethane panel with a wet film thickness of 150 microns and air-dried for 7 days, and then the resulting coating film was subjected to the test according to GB/T 3324-2008 and GB/T 23999-2009 for testing its chemical resistance and was rated where a grade of 5 represents the best chemical resistance, and 0 represents the worst chemical resistance.

### EXAMPLES

The raw materials used in examples were listed in Table 1 below.

TABLE 1

| Items | Description |
|---|---|
| 1 | Acrylic emulsion |
| 2 | Acrylic emulsion |
| 3 | Polyurethane modified acrylic |
| | emulsion |
| 4 | Waterborne polyurethane dispersion |
| 5 | Cosolvent - Dipropylene glycol |
| | methyl ether |
| 6 | Defoamer - Polyether siloxane |
| 7 | Leveling agent - polyether modified |
| | polysiloxane |
| 8 | Thickener - nonionic urethane |
| | rheology modifier |
| 9 | Aqueous medium - deionized water |
| 10 | Oligosiloxane |
| 11 | Epoxy silane coupling agent |
| 12 | Self-matting latex |
| 13 | Silica aerogel matting agent |
| 14 | Silica matting agent |

### Waterborne Wood Coating Composition

According to the amount shown in Table 2, the aqueous latex, co-solvent, defoamer, leveling agent, thickener and water in sequence were added to the production tank with stirring until uniform. Then the oligosiloxane in an amount as shown in Table 2 was added to the production tank with mixing uniformly, and then the resulting mixture was discharged, filtered and packaged to obtain the waterborne wood coating composition according to an embodiment of the present application.

As a control, the aqueous latex, co-solvent, defoamer, leveling agent, thickener and water (Items 1-9 from Table 1 above) in sequence were added to the production tank with stirring until uniform. Then different types of commercial matting agent (Items 12-14 from Table 1 above) in an amount as shown in Table 2 were added to the production tank with stirring evenly, and then the resulting mixture was discharged, filtered and packaged to obtain a control waterborne wood coating composition.

TABLE 2
Components of waterborne wood coating compositions and their amounts

| Components | CEx. A | CEx. B | CEx. C | CEx. D | CEx. E | CEx. F | Control 1 | Control 2 | Ex. 1 | Ex. 2 | Ex 3 | Ex. 4 |
|---|---|---|---|---|---|---|---|---|---|---|---|---|
| Acrylic | 60 | 75 | 75 | 50 | 75 | 75 | 75 | 75 | 75 | 75 | 75 | 75 |
| Emulsion | | | | | | | | | | | | |
| Cosolvent | 6.5 | 6.5 | 6.5 | 6.5 | 6.5 | 6.5 | 6.5 | 6.5 | 6.5 | 6.5 | 6.5 | 6.5 |
| Defoamer | 1.7 | 1.7 | 1.7 | 1.7 | 1.7 | 1.7 | 1.7 | 1.7 | 1.7 | 1.7 | 1.7 | 1.7 |
| Leveling agent | 0.3 | 0.3 | 0.3 | 0.3 | 0.3 | 0.3 | 0.3 | 0.3 | 0.3 | 0.3 | 0.3 | 0.3 |
| Thickener | 1.035 | 1.035 | 1.035 | 1.035 | 1.035 | 1.035 | 1.035 | 1.035 | 1.035 | 1.035 | 1.035 | 1.035 |
| water | 20.465 | 14.965 | 14.965 | 19.465 | 14.465 | 14.465 | 15.465 | 15.465 | 15.465 | 15.465 | 15.465 | 15.465 |
| Epoxy silane | / | / | / | / | / | / | / | 3 | / | / | / | / |
| coupling agent | | | | | | | | | | | | |
| Oligosilane | / | / | / | / | / | / | / | / | 3 | 4 | 5 | 10 |
| Self-matting | 10 | / | / | 21 | / | / | / | / | / | / | / | / |
| latex | | | | | | | | | | | | |
| Silica aerogel | / | 0.5 | / | / | 1 | / | / | / | / | / | / | / |
| matting agent | | | | | | | | | | | | |
| Silica matting | / | / | 0.5 | / | / | 1 | / | / | / | / | / | / |
| agent | | | | | | | | | | | | |
| Total | 100 | 100 | 100 | 100 | 100 | 100 | 100 | 103 | 103 | 104 | 105 | 110 |

### Optical Properties of Waterborne Wood Coating Composition

According to the test methods shown in the test section, the waterborne paint without oligosiloxane was used as a control sample 1, and it was compared with the waterborne wood coating compositions 1-4 of the present application and the comparative waterborne wood coating compositions A to F. These coating compositions were applied to an aged polyurethane panel with a wet film thickness of 150 microns and air dried for 7 days, and then the samples were tested using the gloss meter BYK4565 for their 60° gloss.

In addition, a coating composition formed by incorporating small molecule epoxy silane coupling agent into the waterborne paint was used as a control sample 2, and the 60° gloss of the obtained coating film was measured as described above.

The test results are summarized in Table 3 below.

TABLE 3
Gloss of the coating films formed from
the waterborne wood coating composition

| | 60° gloss |
|---|---|
| Control 1 | 69.1 |
| Control 2 | 68.3 |
| CEx. A | 47.6 |
| CEx. B | 46.9 |
| CEx. C | 48.1 |
| CEx. D | 28.2 |
| CEx. E | 28.9 |
| CEx. F | 27.3 |
| Ex. 1 | 40.3 |
| Ex. 2 | 27.8 |
| Ex. 3 | 22.1 |
| Ex. 4 | 12.5 |

It was shown in Table 3 above that incorporation of at least one oligosiloxane into the waterborne paint significantly reduced gloss of the coating composition, and even a matte coating composition, i.e. with a 60° gloss of less than 25 was obtained, which oligosiloxane is superior to conventional commercial matting agents in terms of matting performance. In contrast, incorporation of small molecular epoxy silanes, such as γ-glycidoxypropyl trimethoxy silane, with functional groups that are hydrolysable to remove small molecules in waterborne paints did not obviously reduce gloss of the coating composition. It can be seen that incorporation of oligomer polysiloxane with hydrolyzable functional groups into the waterborne paint is necessary to reduce surface gloss of the coating film.

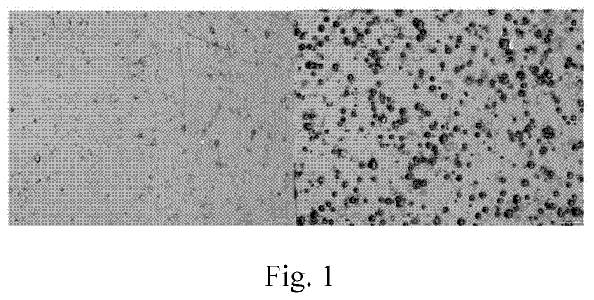

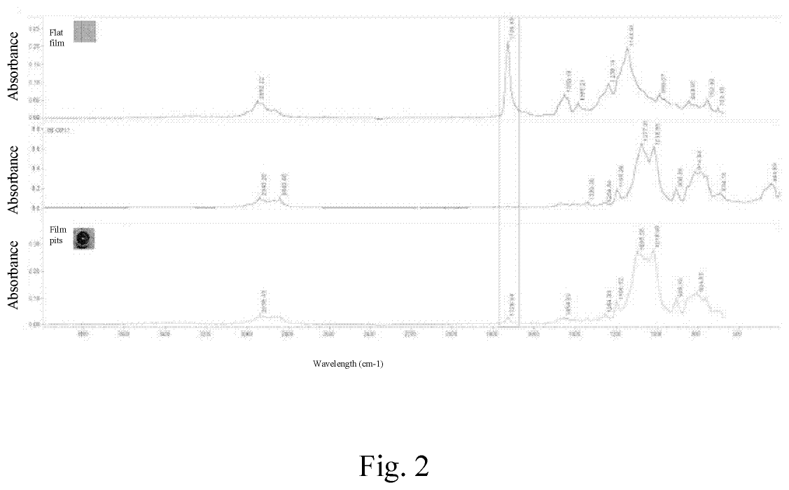

In order to further study the surface characteristics of the coating film, both electron microscopy and infrared analysis were conducted on the surface of the coating film formed from the coating composition of Example 2, and the obtained results were shown in FIGS. 1 and 2. It was shown in FIG. 1 that incorporation of at least one oligosiloxane into the waterborne paint greatly improved the surface roughness of the coating film formed from the resulting coating composition and there were a lot of pits on the surface of the coating film. It was speculated that some of these pits were caused by the facts that the oligosiloxane was self-condensed into silicone microparticles and the silicone microparticles had a surface tension lower than that of the surrounding resins. In contrast, the control sample 1 containing no oligosiloxane had a relatively smooth surface. In addition, it was shown from the infrared spectrum results of FIG. 2 that the oligomeric epoxy siloxane would undergo cross-linking reaction with the carboxyl functionalized aqueous latex during the film formation process, which was manifested by decrease in the absorption intensity of the carboxyl characteristic peak at 1728 cm⁻¹.

Next, the waterborne wood coating compositions of Comparative Examples D-F with similar glossiness were compared with the waterborne wood coating composition of Example 2, and the transparency of each coating film was measured. The test results were summarized in Table 4 below.

TABLE 4
Transparency of coating film formed by
waterborne wood coating composition

| | | Transparency (on a glass panel) | | |
|---|---|---|---|---|
| | 60° | Visible light | Blue light | Violet light |
| Samples | gloss | (550 nm) | (430 nm) | (395 nm) |
| CEx. D | 28.2 | 82.9% | 82.0% | 80.4% |
| CEx. E | 28.9 | 79.6% | 77.1% | 72.9% |
| CEx. F | 27.3 | 83.4% | 81.7% | 78.4% |
| Ex. 2 | 27.8 | 83.7% | 82.1% | 81.1% |

It was shown in Table 4 above that the waterborne wood coating composition obtained by incorporating at least one oligosiloxane into the waterborne paint had comparable, or even better transparency compared with the control waterborne wood coating composition with similar gloss.

### Film Performances of Waterborne Wood Coating Composition

According to the test methods shown in the test section, the waterborne wood coating composition 2 of the present application and the comparative waterborne wood coating compositions D-F with similar gloss were compared, and the coating films formed from these coating compositions were covered by the chemicals shown in Table 5 below for a certain period of time for testing their resistance to chemicals. The test results were summarized in Table 5 below.

TABLE 5
Chemical resistance of coating film formed
from waterborne wood coating composition

| Chemicals | CEx. D | CEx. E | CEx. F | Ex. 2 |
|---|---|---|---|---|
| 50% ethanol (1 hour) | 4 | 3.5 | 3.5 | 4 |
| 4% coffee solution (1 hour) | 5 | 5 | 5 | 5 |
| Tea solution (1 hour) | 5 | 5 | 5 | 5 |
| Vinegar (1 hour) | 5 | 5 | 5 | 5 |
| Aqueous sodium bicarbonate | 5 | 5 | 5 | 5 |
| solution/50 g/L (1 hour) | | | | |
| 10% aqueous sodium carbonate | 3 | 3 | 3 | 5 |
| solution (24 hours) | | | | |
| 10% aqueous acetic acid | 3 | 3 | 3 | 3.5 |
| solution (24 hours) | | | | |
| Water (24 hours) | 3.5 | 3 | 3 | 3.5 |
| Hot water at 100° C. (20 minutes) | 4 | 3 | 3 | 4 |

It was shown in Table 5 that compared with the comparative waterborne wood coating compositions D-F with similar gloss, the waterborne wood coating composition obtained by incorporating oligosiloxane into the waterborne paint according to an embodiment of the present application had improved chemical resistance, especially significantly improved alkali resistance.

### Other Waterborne Wood Coating Compositions

In order to verify the matting effect of oligosiloxane of the present application in other waterborne paints, the same amount of waterborne acrylic resin, polyurethane modified acrylic emulsion, and waterborne acrylic dispersion were used to replace the acrylic dispersion of Example 2, and the waterborne wood coating compositions of the present application were prepared as above.

Then, these coating compositions were applied on an aged polyurethane panel with a wet film thickness of 150 microns and air dried for 7 days, and then the 60° gloss of the samples was tested using gloss meter BYK4565. The test results were shown in Table 6 below.

TABLE 6
Gloss of coating films formed from other
waterborne wood coating compositions

| | 60° gloss |
|---|---|
| Waterborne acrylic resin | 29.4 |
| Polyurethane modified acrylic emulsion | 28.7 |
| (N-Methylpyrrolidone free) | |
| Waterborne polyurethane dispersion | 33.5 |

It was shown in Table 6 above that the oligosiloxane according to the present application was suitable for being incorporated into waterborne paints formulated from various aqueous latexes, and has a very wide application range for promotion.

### Embodiments

Embodiment 1: A waterborne wood coating composition comprising: i) a waterborne paint comprising an aqueous dispersion of polymer particles, and, optionally, at least one additional additive comprising at least one pigment/filler, at least one cosolvent, at least one thickener, at least one leveling agent, at least one defoamer, or any combination thereof; and ii) at least one oligosiloxane, the at least one oligosiloxane having one or more functional groups that are hydrolysable to release small molecules, wherein the waterborne wood coating composition forms a coating film having a 60° gloss of not higher than 40.

Embodiment 2: An embodiment of Embodiment 1, wherein the waterborne wood coating composition is substantially free of a matting powder.

Embodiment 3: An embodiment of any of Embodiments 1 or 2, wherein the small molecules include at least one alcohol, at least one carboxylic acid, at least one oxime, water, or combinations thereof.

Embodiment 4: An embodiment of any of Embodiments 1 to 3, wherein the polymer particles have one or more active hydrogen functional groups.

Embodiment 5: An embodiment of any of Embodiments 1 to 4, wherein the polymer particles have one or more active hydrogen functional groups selected from —COOH, —OH, —SH, secondary amino groups, primary amino groups, or combinations thereof.

Embodiment 6: An embodiment of Embodiment 5, wherein the one or more active hydrogen functional groups are functionalized with carboxyl groups.

Embodiment 7: An embodiment of any of Embodiments 1 to 6, wherein the aqueous dispersion of polymer particles comprises an aqueous dispersion of vinyl acetate polymer particles, an aqueous dispersion of acrylics polymer particles, an aqueous dispersion of silicone polymer particles, an aqueous dispersion of polyurethane polymer particles, an aqueous dispersion of polyurethane polyacrylic polymer particles, an aqueous dispersion of fluoropolymer polymer particles, or any combination thereof.

Embodiment 8: An embodiment of any of Embodiments 1 to 7, wherein the at least one oligosiloxane further comprises one or more moieties with at least one active hydrogen reactive functional group.

Embodiment 9: An embodiment of any of Embodiments 1 to 8, wherein the at least one oligosiloxane has a structure represented by Formula 1:

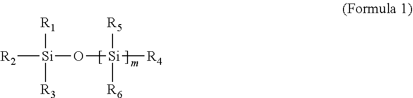

in which
at least one of R1, R2, R3, R4, R5, and R6 is a functional group that is hydrolysable to release small molecules, and the functional group is one or more selected from C1-C6 alkoxy and C2-C6 alkenyloxy , C6-C10 aryloxy group, C1-C6 alkanoyloxy group, C6-C10 aroyloxy group, C1-C6 alkane oxime group and C6-C10 aryl ketoxime group, preferably from C1-C6 alkoxy; and
at least one of R1, R2, R3, R4, R5, and R6 is a moiety with an active hydrogen-reactive functional group, and the active hydrogen-reactive functional group is one or more selected from epoxy groups, hydroxyl groups, amino groups, and isocyanate groups, preferably from epoxy groups; and
m is not 0, preferably an integer from 1 to 10.

Embodiment 10: An embodiment of any of Embodiments 1 to 7, wherein the at least one oligosiloxane further comprises two or more moieties with at least one active hydrogen reactive functional group.

Embodiment 11: An embodiment of Embodiment 10, wherein the oligosiloxane has a structure represented by Formula 2:

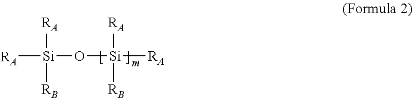

RA represents a functional group that is hydrolysable to release small molecules, and the functional group is one or more selected from C1-C6 alkoxy and C2-C6 alkenyloxy , C6-C10 aryloxy group, C1-C6 alkanoyloxy group, C6-C10 aroyloxy group, C1-C6 alkane oxime group and C6-C10 aryl ketoxime group, preferably from C1-C6 alkoxy; and
RB represents a moiety with an active hydrogen-reactive functional group, and the active hydrogen-reactive functional group is one or more selected from epoxy groups, hydroxyl groups, amino groups, and isocyanate groups, preferably from epoxy groups; and
m is not 0, preferably an integer from 1 to 10.

Embodiment 12: An embodiment of any of Embodiments 1 to 11, wherein the at least one oligosiloxane is substantially insoluble in water.

Embodiment 13: An embodiment of any of Embodiments 1 to 12, wherein the at least one oligosiloxane is present in an amount of 1 to 10 wt % relative to the total weight of the waterborne wood coating composition

Embodiment 14: A wood article, comprising: (a) a wood substrate having at least one major surface; and (b) at least one coating film, the coating film being formed by the waterborne wood coating composition according to any one of Embodiments 1 to 13 directly or indirectly applied on the at least one major surface of the wood substrate

Embodiment 15: An embodiment of Embodiment 14, wherein the wood substrate comprises hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosma japonicum, Catalpa wood, Dryobalanops spp., fir, oak, rubber, wood composites, or combinations thereof.

While what has been described with respect to a number of embodiments and examples, those skilled in the art, having benefit of what is disclosed herein, will appreciate that other embodiments can be devised which do not depart from the scope and spirit of what is disclosed herein.

1. A waterborne wood coating composition comprising:
i) a waterborne paint comprising an aqueous dispersion of polymer particles, and, optionally, at least one additional additive comprising at least one pigment/filler, at least one cosolvent, at least one thickener, at least one leveling agent, at least one defoamer, or any combination thereof; and
ii) at least one oligosiloxane, the at least one oligosiloxane having one or more functional groups that are hydrolysable to release small molecules,
wherein the waterborne wood coating composition forms a coating film having a 60° gloss of not higher than 40.

2. The waterborne wood coating composition of claim 1, wherein the waterborne wood coating composition is substantially free of a matting powder.

3. The waterborne wood coating composition of claim 1, wherein the small molecules include at least one alcohol, at least one carboxylic acid, at least one oxime, water, or combinations thereof.

4. The waterborne wood coating composition according to claim 1, wherein the polymer particles have one or more active hydrogen functional groups.

5. The waterborne wood coating composition according to claim 1, wherein the polymer particles have one or more active hydrogen functional groups selected from —COOH, —OH, —SH, secondary amino groups, primary amino groups, or combinations thereof.

6. The waterborne wood coating composition according to claim 5, wherein the one or more active hydrogen functional groups are functionalized with carboxyl groups.

7. The waterborne wood coating composition according to claim 1, wherein the aqueous dispersion of polymer particles comprises an aqueous dispersion of vinyl acetate polymer particles, an aqueous dispersion of acrylics polymer particles, an aqueous dispersion of silicone polymer particles, an aqueous dispersion of polyurethane polymer particles, an aqueous dispersion of polyurethane polyacrylic polymer particles, an aqueous dispersion of fluoropolymer polymer particles, or any combination thereof.

8. The waterborne wood coating composition according to claim 1, wherein the at least one oligosiloxane further comprises one or more moieties with at least one active hydrogen reactive functional group.

9. The waterborne wood coating composition according to claim 1, wherein the at least one oligosiloxane has a structure represented by Formula 1: 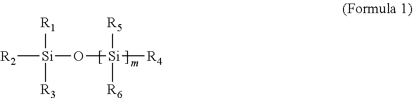
in which
at least one of R1, R2, R3, R4, R5, and R6 is a functional group that is hydrolysable to release small molecules, and the functional group is one or more selected from C1-C6 alkoxy and C2-C6 alkenyloxy, C6-C10 aryloxy group, C1-C6 alkanoyloxy group, C6-C10 aroyloxy group, C1-C6 alkane oxime group and C6-C10 aryl ketoxime group, preferably from C1-C6 alkoxy; and
at least one of R1, R2, R3, R4, R5, and R6 is a moiety with an active hydrogen-reactive functional group, and the active hydrogen-reactive functional group is one or more selected from epoxy groups, hydroxyl groups, amino groups, and isocyanate groups, preferably from epoxy groups; and
m is not 0, preferably an integer from 1 to 10.

10. The waterborne wood coating composition according to claim 1, wherein the at least one oligosiloxane further comprises two or more moieties with at least one active hydrogen reactive functional group.

11. The waterborne wood coating composition according to claim 10, wherein the oligosiloxane has a structure represented by Formula 2: 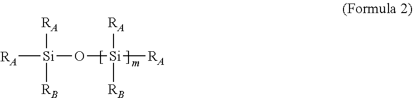
RA represents a functional group that is hydrolysable to release small molecules, and the functional group is one or more selected from C1-C6 alkoxy and C2-C6 alkenyloxy , C6-C10 aryloxy group, C1-C6 alkanoyloxy group, C6-C10 aroyloxy group, C1-C6 alkane oxime group and C6-C10 aryl ketoxime group, preferably from C1-C6 alkoxy; and
RB represents a moiety with an active hydrogen-reactive functional group, and the active hydrogen-reactive functional group is one or more selected from epoxy groups, hydroxyl groups, amino groups, and isocyanate groups, preferably from epoxy groups; and
m is not 0, preferably an integer from 1 to 10.

12. The waterborne wood coating composition according to claim 1, wherein the at least one oligosiloxane is substantially insoluble in water.

13. The waterborne wood coating composition according to claim 1, wherein the at least one oligosiloxane is present in an amount of 1 to 10 wt % relative to the total weight of the waterborne wood coating composition.

14. A wood article, comprising
a wood substrate having at least one major surface; and
at least one coating film, the coating film being formed by the waterborne wood coating composition according to claim 1 directly or indirectly applied on the at least one major surface of the wood substrate.

15. The wood article of claim 14, wherein the wood substrate comprises hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosmajaponicum, Catalpa wood, Dryobalanops spp., fir, oak, rubber, wood composites, or combinations thereof.
